(19) United States
(12) Patent Application Publication
(10) Pub. No.: US 2007/0283704 A1
(43) Pub. Date: Dec. 13, 2007

(54) Cryopump and semiconductor device manufacturing apparatus using the cryopump

(75) Inventor: Hidekazu Tanaka, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: SUMITOMO HEAVY INDUSTRIES, LTD., Tokyo (JP)

(21) Appl. No.: 11/654,505

(22) Filed: Jan. 18, 2007

(30) Foreign Application Priority Data
Jun. 7, 2006 (JP) 2006-158619

(51) Int. Cl. B01D 8/00

(52) U.S. Cl. 62/55.5

(57) ABSTRACT

A cryopump is disclosed. The cryopump includes a cryopump main body connected to a vacuum chamber via an inlet. The cryopump main body includes a vacuum container. A shielding section, a two-stage type cryogenic cooler, a baffle, and first cryopanel and second cryopanels are provided in the vacuum container. A top surface of the first cryopanel is disposed at a position nearest to a surface of the baffle. The top surface of the first cryopanel is disposed almost parallel to the surface of the baffle.

### BACKGROUND OF THE INVENTION

1. Field of the Invention

The present invention generally relates to a cryopump and a semiconductor device manufacturing apparatus using the cryopump.

2. Description of the Related Art

Generally, in the semiconductor device manufacturing industry and the flat panel manufacturing industry which manufactures a liquid crystal panel or a plasma display panel, a thin film forming process, a heat treatment process, a dry etching process, and so on are executed in an atmosphere of argon gas or nitrogen gas in a vacuum chamber. In order to prevent impurities from being mixed during the above processes, a clean vacuum pump is required. A cryopump decreases gas molecules in the vacuum chamber by statically condensing or absorbing the gas molecules without using a mechanism having operations such as rotation; therefore, a high vacuum can be obtained without contamination inside the vacuum chamber.

FIG. 1 is a cut-away side view of a cryopump. As shown in FIG. 1, a cryopump 100 provides a cryogenic cooler 102, a shielding section 103, a baffle 104 disposed at an inlet 101a connected to a vacuum chamber 110, and a cryopanel 108 in a vacuum container 101. The shielding section 103 and the baffle 104 are cooled to approximately 80 K by a first cooling stage 105 of the cryogenic cooler 102. With this, the inside of the cryopump 100 is shielded from radiated heat of the outside which is at room temperature. In addition, the baffle 104 discharges H₂O in the vacuum chamber 110 by condensing H₂O.

Further, the cryopanel 108 is cooled to a cryogenic temperature of 20 K or less by being attached to a second cooling stage 106. Gas, such as nitrogen gas, oxygen gas, and argon gas is condensed on the surface of the cryopanel 108 by passing through the baffle 104. FIG. 2 is a cut-away side view of a part of the cryopump 100 shown in FIG. 1. As shown in FIG. 2, the above gas forms frost 112 including ice on the surface of the cryopanel 108 by being condensed. When discharge operations of the cryopump 100 are continued, the frost 112 grows and approaches the baffle 104. The above is described in Patent Document 1.

[Patent Document 1] PCT Internal Application No. WO 2005/050017

However, in the cryopump 100, inside the shielding section 103, since the cryopanel 108 condenses the gas, pressure is high right under the baffle 104; however, the pressure becomes gradually low near the cryopanel 108.

In addition, the top section 108a of the cryopanel 108 is secured to the second cooling stage 106 by securing members such as bolts 109. As shown in FIG. 2, head surfaces 109a of the bolts 109 protrude from a metal plate of the cryopanel 108 to the side of the baffle 104. Therefore, pressure applied to the head surfaces 109a of the bolts 109 is greater than that to the top section 108a of the cryopanel 108. Consequently, the frost 112 grows more quickly on the head surfaces 109a of the bolts 109 than on the top section 108a of the cryopanel 108. That is, in the frost 112, the thickness A on the head surface 109a is remarkably greater than the thickness B on the top section 108a. Then, the surface temperature of the frost 112 becomes non-uniform and the discharge amount becomes low. In addition, when the frost 112 contacts the baffle 104 or the surface temperature of the frost 112 becomes excessively non-uniform, the discharge can no longer be executed.

### SUMMARY OF THE INVENTION

In a preferred embodiment of the present invention, there is provided a cryopump and a semiconductor device manufacturing apparatus using the cryopump whose discharge amount can be large without making the size large.

According to one aspect of the present invention, there is provided a cryopump. The cryopump includes a vacuum container, a two-stage type cryogenic cooler having a first cooling stage and a second cooling stage disposed in the vacuum container, a shielding section on whose one end an inlet open to a vacuum chamber in which gas is discharged is disposed and with whose other end the first cooling stage makes contact, a baffle which contacts the shielding section at the side of the inlet, a first cryopanel disposed in a space surrounded by the shielding section and the baffle which first cryopanel is in contact with the second cooling stage, and a securing member which secures the first cryopanel to the second cooling stage. The first cryopanel includes a flat top surface almost parallel to the surface of the baffle and the top flat surface is disposed at the same level as the level of the surface of the securing member or at a level nearer to the surface of the baffle than the level of the surface of the securing member.

According to another aspect of the present invention, the top flat surface of the first cryopanel disposed at a position nearest to the baffle is almost parallel to the surface of the baffle. The top flat surface is secured to the second cooling stage of the two-stage type cryogenic cooler by a securing member, for example, bolts and nuts so that the securing member does not protrude from the top flat surface. Therefore, frost formed of gas flowing from the baffle by being condensed is deposited on the top flat surface with a uniform thickness. Consequently, the surface temperature of the frost becomes uniform and the frost is prevented from contacting the baffle. In addition, the frost is not excessively deposited on a part of the top flat surface of the first cryopanel. Therefore, the cryopump can increase the discharge amount without making the size large.

According to another aspect of the present invention, there is provided a semiconductor device manufacturing apparatus. The semiconductor device manufacturing apparatus includes a vacuum chamber; a unit which applies a film forming process, a heat treatment process, or another process to a substrate of a semiconductor device disposed in the vacuum camber; and the above cryopump for discharging gas in the vacuum chamber.

According to an embodiment of the present invention, since the cryopump can increase the discharge amount without making the size large, the working time of the semiconductor device manufacturing apparatus can be decreased while the size of the semiconductor device manufacturing apparatus is maintained. Consequently, the productivity of the semiconductor device manufacturing apparatus can be increased. With this, cost of a semiconductor device manufactured by the semiconductor device manufacturing apparatus can be reduced.

Other objects, features, and advantages of the present invention will become more apparent from the following detailed description when read in conjunction with the accompanying drawings.

### BRIEF DESCRIPTION OF THE DRAWINGS

FIG. 1 is a cut-away side view of a cryopump;

FIG. 2 is a cut-away side view of a part of the cryopump shown in FIG. 1;

FIG. 3 is a cut-away side view of a cryopump according to a first embodiment of the present invention;

FIG. 4 is an enlarged perspective view of a first cryopanel and second cryopanels shown in FIG. 3;

FIG. 5 is an enlarged cut-away side view of a part of the cryopump where the first cryopanel and a baffle exist;

FIG. 6 is a cut-away side view in which frost is deposited on a top section of the first cryopanel shown in FIG. 5;

FIG. 7 is a cut-away side view of a cryopump according to a first modified example of the first embodiment of the present invention;

FIG. 8 is a cut-away side view of a cryopump according to a second modified example of the first embodiment of the present invention;

FIG. 9 is an enlarged cut-away side view of a part of the cryopump shown in FIG. 8 where a first cryopanel and a baffle exist;

FIG. 10 is a cut-away side view in which frost is deposited on a top section and a flat surface of the first cryopanel shown in FIG. 9;

FIG. 11 is a table showing experimental results in which the discharge amounts in the embodiment of the present invention and the comparison example are shown; and

FIG. 12 is a cut-away side view of a semiconductor device manufacturing apparatus according to a second embodiment of the present invention.

### DETAILED DESCRIPTION OF THE PREFERRED EMBODIMENTS

In the following, embodiments of the present invention are described with reference to the accompanying drawings.

### First Embodiment

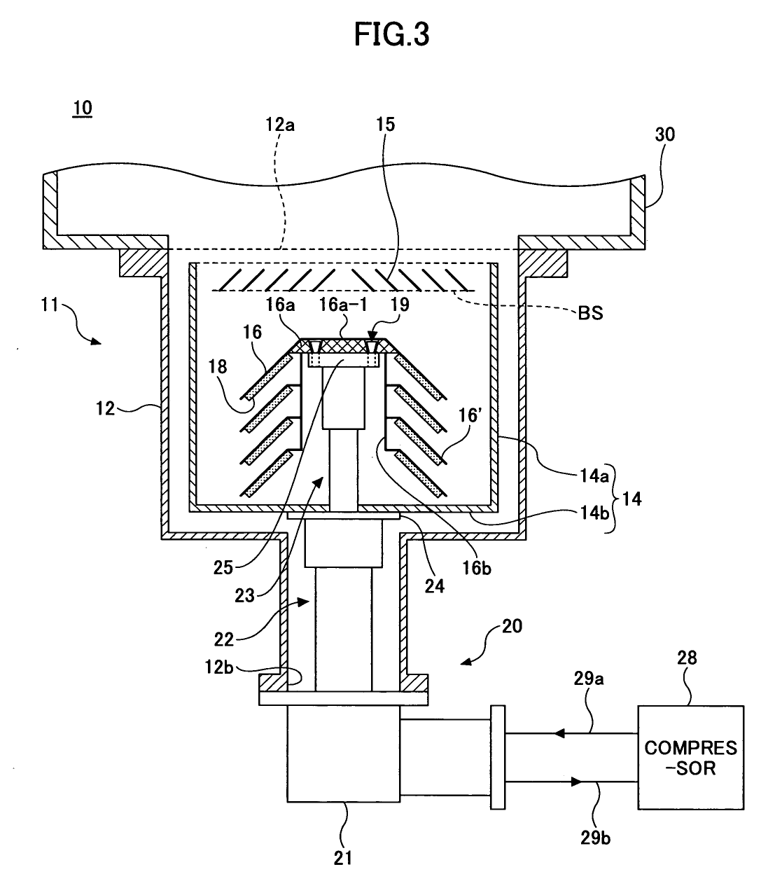

FIG. 3 is a cut-away side view of a cryopump according to a first embodiment of the present invention.

As shown in FIG. 3, a cryopump 10 according to the first embodiment of the present invention includes a cryopump main body 11 connected to a vacuum chamber 30 whose inside gas is discharged via an inlet 12a. The cryopump main body 11 includes a vacuum container 12. The vacuum container 12 includes a shielding section 14, a cryogenic cooler 20, a baffle 15, a first cryopanel 16, and second cryopanels 16′. The vacuum container 12 provides a thermometer (not shown) for measuring temperatures of the shielding section 14, the baffle 15, the first cryopanel 16, and the second cryopanels 16′, and a safety valve (not shown) which discharges gas inside the vacuum container 12 to the outside when inside pressure of the vacuum container 12 becomes excessively high.

The vacuum container 12 is formed of a metal material such as stainless steel. One end of the vacuum container 12 is an open end and the open end is the inlet 12a of the vacuum chamber 30. In addition, the other end of the vacuum container 12 is an open end 12b and the open end 12b is secured to a flange of a power unit 21.

The cryogenic cooler 20 is a GM (Gifford-McMahon) type two-stage cryogenic cooler and includes a first cooling section 22, a second cooling section 23, and a compressor 28 which generates a compressed working fluid. In the first cooling section 22 and the second cooling section 23, there are an expander (not shown) which cools the working fluid supplied from the compressor 28 via a supply tube 29a (a collection tube 29b) by adiabatic expansion and a refrigerator (not shown). A first cooling stage 24 which can cool to 80 K or less is provided at the tip of the first cooling section 22. A second cooling stage 25 which can cool to 20 K or less, for example, 10 K to 20 K, is provided at the tip of the second cooling section 23. In addition, the cryogenic cooler 20 provides the power unit 21 for operating a displacer (not shown) which supplies and discharges the working fluid. Further, the cryogenic cooler 20 can be an M-Solvay (modified Solvay) type two-stage cryogenic cooler instead of the GM type two-stage cryogenic cooler. The first cooling stage 24 and the second cooling stage 25 can be formed of a metal material such as stainless steel.

The shielding section 14 includes a cylinder-shaped member 14a and a flange 14b. The cylinder-shaped member 14a is disposed on almost the same axle as the second cooling section 23 of the cryogenic cooler 20, and the flange 14b is formed of the end of the cylinder-shaped member 14a by bending the end toward the inside to the first cooling stage 24. The inner rim of the flange 14b is secured to the first cooling stage 24. The flange 14b and the cylinder-shaped member 14a are cooled to almost the same temperature as the first cooling stage 24 by contact between the flange 14b and the first cooling stage 24.

The baffle 15 is disposed inside the shielding section 14 near the inlet 12a. The baffle 15 is formed of concentric trapezoidal-cone members whose inner diameters are different from each other each of which members has a cavity. The trapezoidal-cone member is formed by cutting off the top of the cone. Then, the top and the end of the baffle 15 are open. Each trapezoidal-cone member is disposed on almost the same axle as the center axle of the second cooling section 23. The side surface of the baffle 15 has a predetermined angle, for example, 35 with the side surface of the cylinder-shaped member 14a.

The baffle 15 is combined with the shielding section 14 by a member such as a beam (not shown) so that heat conduction exists between the baffle 15 and the shielding section 14. Since the heat conduction exists between the shielding section 14 and the first cooling stage 24, the heat of the baffle 15 is transferred to the first cooling stage 24 and the baffle 15 is cooled to approximately 80 K. The baffle 15 adjusts the direction of gas flowing into the cryopump main body 11 and cools the gas. The baffle 15 decreases heat transfer to the first cryopanel 16 and the second cryopanels 16′ by mainly condensing steam contained in the gas. In this, the shape of the baffle 15 is not limited to that shown in FIG. 3.

The shielding section 14 and the baffle 15 are formed of a metal material whose heat conductivity is high, for example, copper or aluminum. In addition, it is preferable that a Ni plated film be formed on the surfaces of the shielding section 14 and the baffle 15 so as to increase corrosion resistance.

The top section 16a of the first cryopanel 16 is secured to the upper surface of the second cooling stage 25. The first cryopanel 16 and the second cryopanels 16′ provide a cylinder-shaped section 16b extending downward. Plural umbrella-shaped metal plates are disposed at the top section 16a and on the surface of the cylinder-shaped section 16b so that the plural umbrella-shaped metal plates are isolated. The first cryopanel 16 and the second cryopanels 16′ are formed of a metal material whose heat conductivity is high, for example, copper or aluminum. Since heat conduction exists between the top section 16a of the first cryopanel 16 and the second cooling stage 25, the temperature of the first cryopanel 16 can be maintained to be the same temperature as that of the second cooling stage 25, for example, 10 K to 20 K. In this, a Ni plated film can be formed on the surfaces of the first cryopanel 16 and the second cryopanels 16′ so as to increase corrosion resistance.

An absorption panel 18 is formed on the rear surface of the metal plate of each of the first cryopanel 16 and the second cryopanels 16′. The absorption panel 18 is made of epoxy resin having heat conductivity by adhering absorbent material such as activated carbon on the epoxy resin which absorbs gas such as hydrogen gas, neon gas, and helium gas which gas is not condensed by the first cryopanel 16 and the second cryopanels 16′. In this, the position where the absorption panel 18 is formed is not limited to the rear surface of the metal plate of each of the first cryopanel 16 and the second cryopanels 16′.

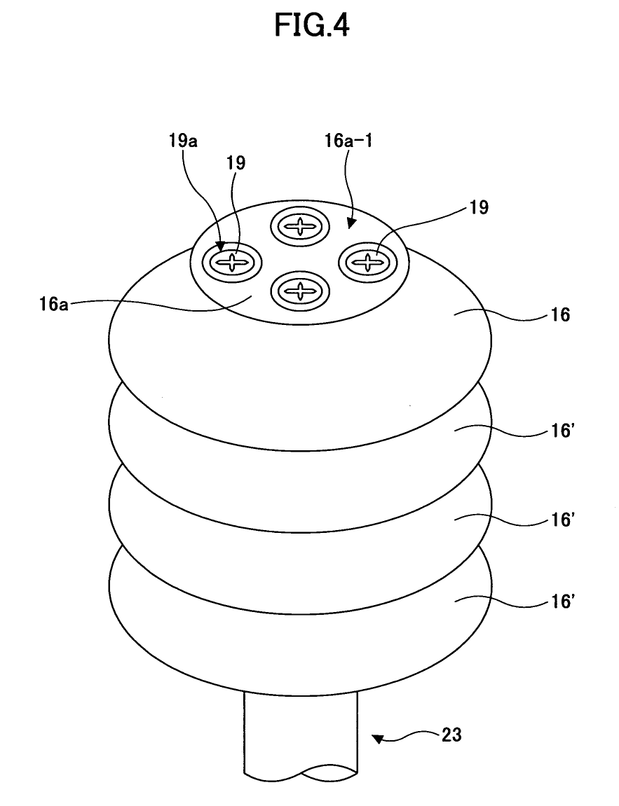

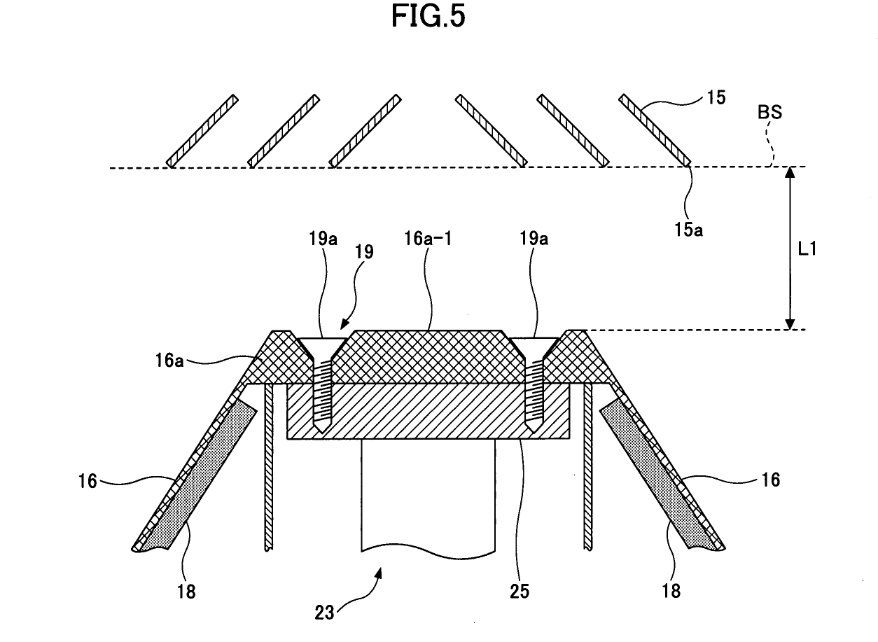

FIG. 4 is an enlarged perspective view of the first cryopanel 16 and the second cryopanels 16′ shown in FIG. 3. FIG. 5 is an enlarged cut-away side view of a part of the cryopump 10 where the first cryopanel 16 and the baffle 15 exist.

As shown in FIG. 5, the top section 16a of the first cryopanel 16 is secured to the second cooling stage 25 by screws (described below in detail). Since the first cryopanel 16 is firmly secured to the second cooling stage 25 by the screws, non-stable contact between the first cryopanel 16 and the second cooling stage 25 can be avoided when the cryopump 10 is operated. As the method of securing the first cryopanel 16 to the second cooling stage 25, a welding method can be used. However, by the screw securing method, a wide range of materials can be used for the first cryopanel 16 and the second cooling stage 25 without considering weld-ability, and the first cryopanel 16 can be easily exchanged. In this, the screw securing method includes a securing method using a bolt and a nut.

In FIG. 5, threaded holes are formed in the second cooling stage 25, and through holes are formed in the top section 16a of the first cryopanel 16 from which through hole a screw 19 is inserted and by which through hole the head of the screw 19 can fix the top section 16a of the first cryopanel 16. The top section 16a of the first cryopanel 16 has a thickness within which the screw 19 can be completely contained; that is, the top section 16a has a thickness so that the head of the screw 19 does not protrude from a top surface 16a-1 of the top section 16a. In other words, it is determined that the level of the surface 19a of the screw 19 coincides with or is less than the level of the top surface 16a-1 of the top section 16a.

In the cryopump 10, the top surface 16a-1 of the first cryopanel 16 is disposed at a position nearest to the baffle 15 almost parallel to the baffle surface BS. That is, the top surface 16a-1 forms a flat surface with a distance L1 from the baffle surface BS.

As shown in FIG. 5, the baffle surface BS is a virtual surface where lower end parts 15a of the plural trapezoidal-cone members contact each other. When the lower end parts 15a do not extend to the same level but instead are disposed in up and down directions, the baffle surface BS can be formed by a virtual surface where some of the lower end parts 15a approach the nearest side of the surface top 16a-1. In addition, as the distance L1, a distance between the surface top 16a-1 and the surface of the inlet 12a of the vacuum container 12 can be used instead of the distance between the surface top 16a-1 and the baffle surface BS.

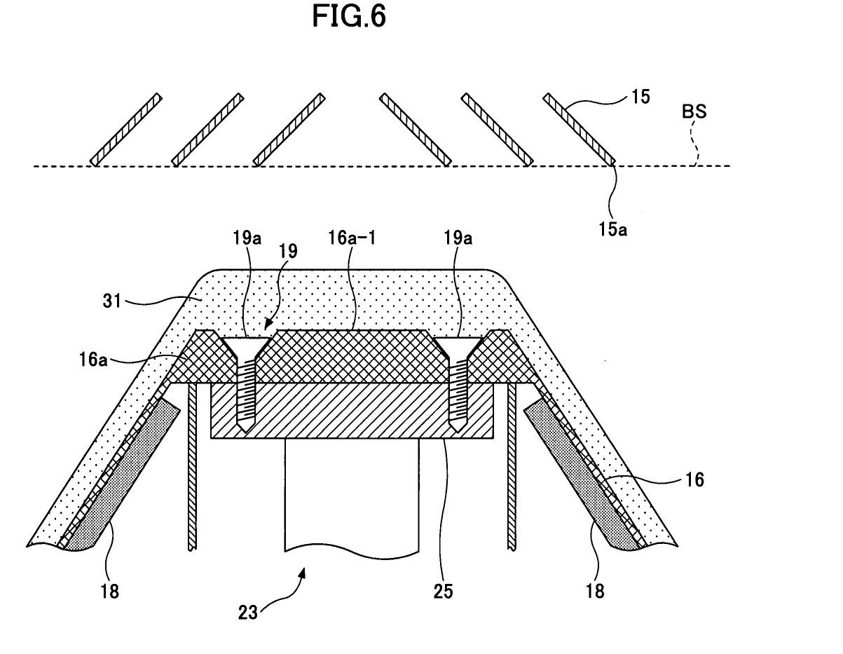

FIG. 6 is a cut-away side view in which frost is deposited on the top section 16a of the first cryopanel 16 shown in FIG. 5. Referring to FIGS. 3 and 6, an effect of the cryopump 10 according to the first embodiment of the present invention is described.

In the cryopump 10, when the cryogenic cooler 20 is operated, gas flows from the vacuum chamber 30 to the vacuum container 12. The baffle 15 condenses steam contained in the gas. The absorption panel 18 absorbs helium gas, neon gas, and hydrogen gas in the gas in which the steam is removed. Nitrogen gas, oxygen gas, and argon gas from the gas in which the steam, the helium gas, the neon gas, and the hydrogen gas are removed form frost 31 on the surface of the first cryopanel 16 by being condensed by the first cryopanel 16.

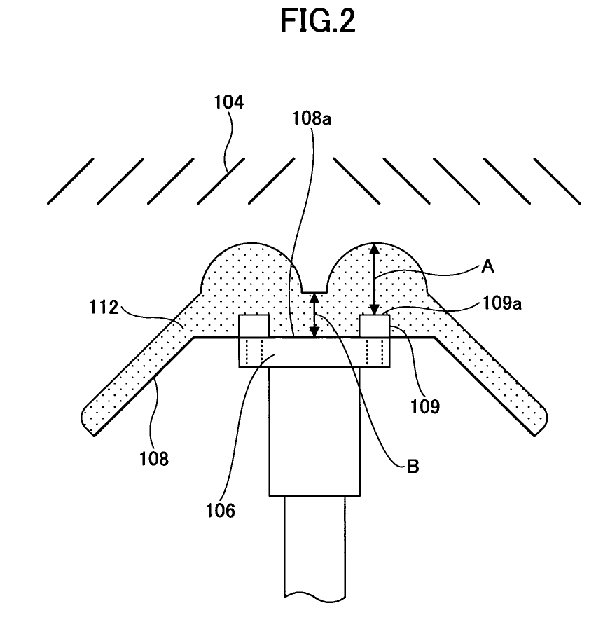

Since the top surface 16a-1 of the first cryopanel 16 is flat and is at the position nearest to the baffle 15, the frost 31 is uniformly formed with the greatest thickness on the top surface 16a-1. Therefore, in the first embodiment of the present invention, a problem in which the frost 112 is selectively deposited on the head surfaces 109a of bolts 109 and the deposited frost contacts the lower end of the baffle 104 shown in FIG. 2 can be avoided. Consequently, the cryopump 10 according to the first embodiment of the present invention can increase the gas discharge amount without making the size of the cryopump 10 large.

As described above, in the cryopump 10, the top surface 16a-1 of the first cryopanel 16 located at the position nearest to the baffle 15 is formed as a flat surface almost parallel to the baffle surface BS. The top section 16a of the first cryopanel 16 is secured to the second cooling stage 25 of the cryogenic cooler 20 by the screws 19, and the heads of the screws 19 do not protrude from the top surface 16a-1. Therefore, gas flowing from the baffle 15 is uniformly condensed on the top surface 16a-1, and the frost 31 is deposited on the top surface 16a-1 with almost the same thickness. Consequently, the surface temperature of the frost 31 becomes almost uniform and the frost 31 is prevented from contacting the baffle 15. That is, since the frost 31 is not excessively deposited on a part of the top surface 16a-1, the frost 31 does not contact the baffle 15. Therefore, the cryopump 10 according to the first embodiment of the present invention can increase the gas discharge amount without making the size of the cryopump 10 large.

As the securing method of the top section 16a to the second cooling stage 25, the following method can be used. That is, threaded screws are formed in the top section 16a, screws are inserted from the lower surface of the second cooling stage 25, and the tips of the screws do not protrude from the top surface 16a-1.

### First Modified Example of First Embodiment

Next, a first modified example of the first embodiment of the present invention is described. In the first modified example of the first embodiment of the present invention, the shape of the first cryopanel is different from that shown in FIG. 3. The others are the same as those in the first embodiment of the present invention. Therefore, the same description is omitted.

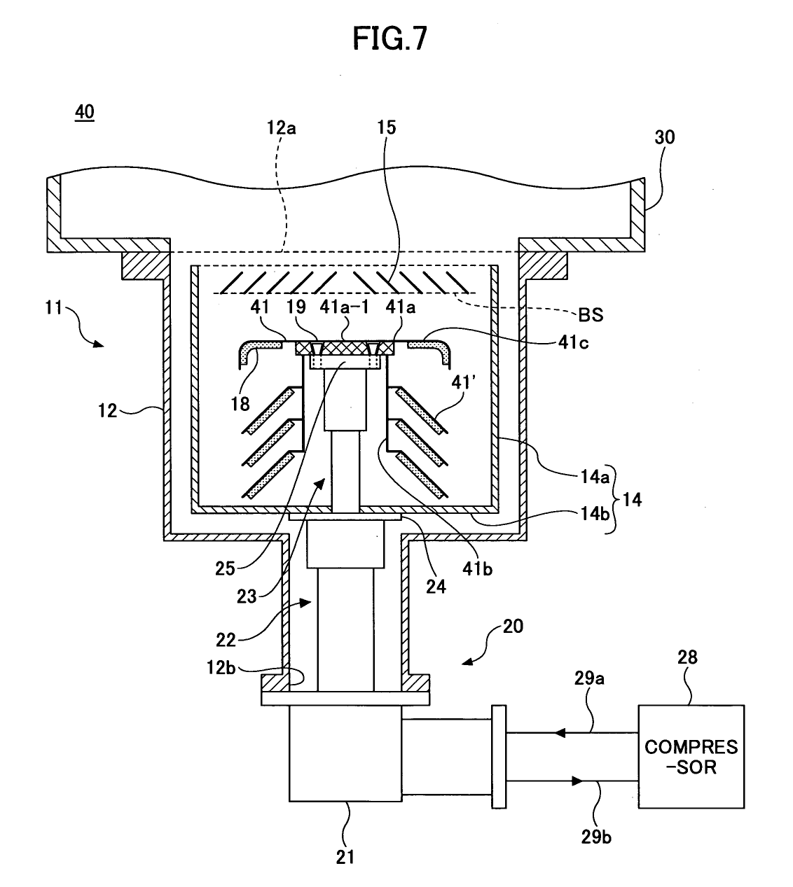

FIG. 7 is a cut-away side view of a cryopump 40 according to the first modified example of the first embodiment of the present invention.

As shown in FIG. 7, in the cryopump 40, a first cryopanel 41 and second cryopanels 41′ are disposed. The first cryopanel 41 located at a position nearest to the baffle 15 provides a top section 41a and a flat surface 41c. The flat surface 41c extends in the outside direction from the top section 41a and the rim part of the flat surface 41c is bent in the downward direction. In the first modified example, the first cryopanel 41 located at the position nearest to the baffle 15 is different from that in the first embodiment. The others are the same as those shown in FIG. 3. That is, the second cryopanels 41′ are the same as the second cryopanels 16′ shown in FIG. 3.

The top section 41a of the first cryopanel 41 has a structure similar to the top section 16a shown in FIGS. 4 and 5. That is, the top section 41a has a thickness so that the heads of the screws 19 can be contained in the thickness. In other words, the heads of the screws 19 do not protrude from a top surface 41a-1.

In addition, the top surface 41a-1 and the flat surface 41c are formed almost parallel to the baffle surface BS, that is, with almost the same distance from the baffle surface BS. In addition to the top surface 41a-1, the flat surface 41c is nearest to the baffle surface BS. Therefore, the area of the surface of the first cryopanel 41 located nearest to the baffle surface BS is larger than that of the first cryopanel 16 in the first embodiment. Consequently, the discharge amount of the cryopump 40 can be larger than that of the cryopump 10 in the first embodiment.

The flat surface 41c is formed of a metal plate. As described above, the rim part of the flat surface 41c is bent in the downward direction. When the rim part of the flat surface 41c is formed with the same surface as the top surface 41a-1, the frost 31 is likely to be deposited at the rim part and the thickness of the frost 31 at the rim part becomes larger than that at the other parts. Consequently, the surface temperature of the frost 31 becomes non-uniform, the frost 31 contacts the baffle 15 and the shielding section 14, and the discharge cannot be executed. In order to solve the above problem, the metal plate of the rim part of the flat surface 41c is bent. The operations of the cryopump 40 are the same as those of the cryopump 10. Therefore, the same description is omitted.

As described above, in the cryopump 40 of the first modified example of the first embodiment, the top surface 41a-1 and the flat surface 41c of the first cryopanel 41 located at the position nearest to the baffle 15 are formed almost parallel to the baffle surface BS. Therefore, the frost 31 is deposited on the top surface 41a-1 and the flat surface 41c with an almost uniform thickness. Accordingly, similar to the cryopump 10, the cryopump 40 can increase the discharge amount without making the size large. Since the area of the top surface 41a-1 and the flat surface 41c in the cryopump 40 is larger than the area of the top surface 16a-1 in the cryopump 10, the discharge amount can be further increased from that of the cryopump 10 in the first embodiment.

It is preferable that the top surface 41a-1 and the flat surface 41c be formed on the same level. However, it is possible for a step to be formed between the top surface 41a-1 and the flat surface 41c and one of them is formed at a position nearest to the baffle 15. In this case, it is preferable that the larger area surface of them be at the position nearest to the baffle 15.

### Second Modified Example of First Embodiment

Next, a second modified example of the first embodiment of the present invention is described. In the second modified example, the shape of a first cryopanel located at a position nearest to the baffle surface BS is different from that shown in FIG. 7 and also a securing method of the first cryopanel to the second cooling stage 25 is different from that shown in FIG. 7. The others are the same as those in the first modified example of the first embodiment of the present invention.

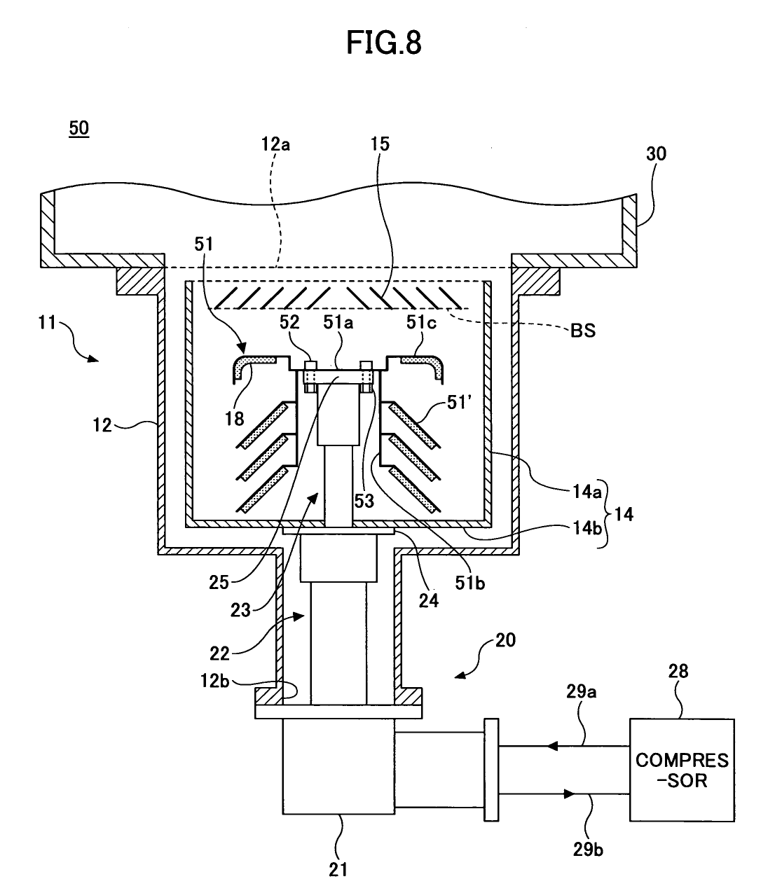

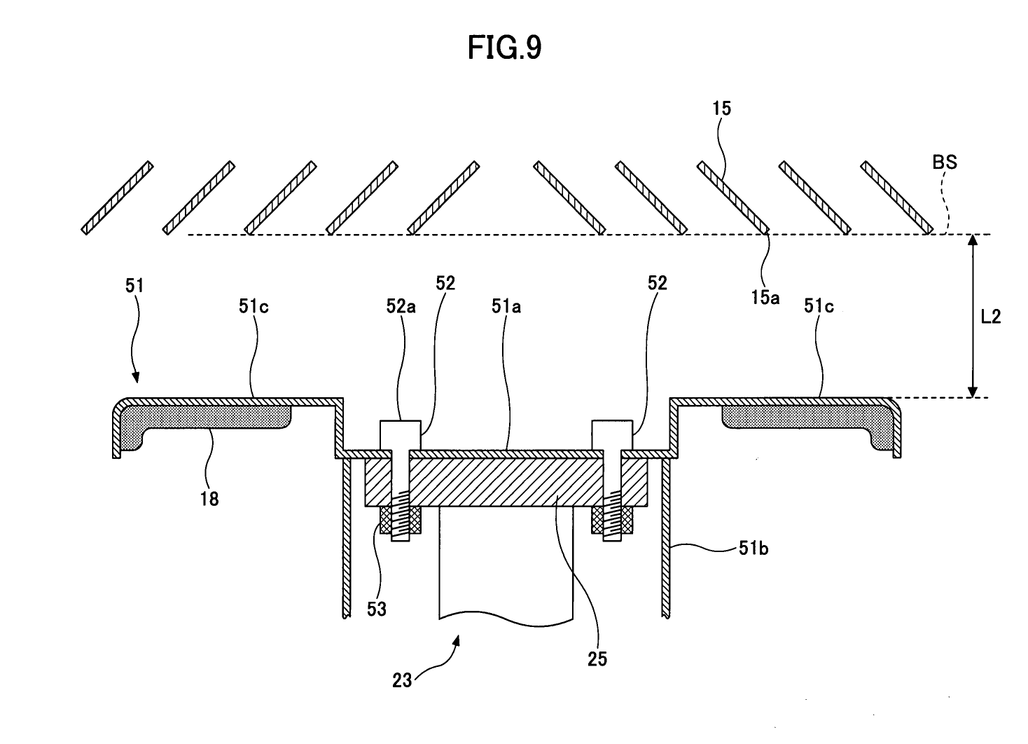

FIG. 8 is a cut-away side view of a cryopump 50 according to the second modified example of the first embodiment of the present invention. FIG. 9 is an enlarged cut-away side view of a part of the cryopump 50 where a first cryopanel 51 and the baffle 15 exist.

As shown in FIGS. 8 and 9, in the cryopump 50, the first cryopanel 51 located at the position nearest to the baffle surface BS provides a concave section (top section) 51a and a flat surface 51c. The first cryopanel 51 is secured to the second cooling stage 25 at the concave section 51a. The flat surface 51c extends in the outside direction from the concave section (top section) 51a and the rim part of the flat surface 51c is bent in the downward direction. The concave section (top section) 51a and the flat surface 51c are formed of a metal plate. The thickness of the top section 51a is almost the same as that of the second cryopanels 51′. That is, the second cryopanels 51′ are almost the same as the second cryopanels 41′ in the first modified example of the first embodiment other than the thickness.

The flat surface 51c is disposed almost parallel to the baffle surface BS with a distance L2 from the baffle surface BS. The flat surface 51c is located at the position nearest to the baffle surface BS.

The top section 51a is secured to the second cooling stage 25 by bolts 52 and nuts 53, and the head of the bolt 52 is disposed lower than the flat surface 51c. In this, as the securing method of the first cryopanel 51 to the second cooling stage 25 is not limited to the above. That is, as long as the head of the bolt 52 does not protrude from the level of the flat surface 51c, for example, the securing method using screws shown in FIG. 3 can be used.

The thickness of the top section 51a is less than that of the top section 16a shown in FIG. 3 and that of the top section 41a shown in FIG. 7. Therefore, the thermal capacity of the first cryopanel 51 can be lower than that of the first cryopanel 16 or 41, and the heat load on the second cooling section 23 can be lowered. In addition, after recovery operations of the cryopump 50, the temperature of the first cryopanel 51 is cooled to 20 K or less by operating the cryogenic cooler 20. At this time, since the thermal capacity of the first cryopanel 51 is made to be low, the cooling rate of the first cryopanel 51 can be high.

In the recovery operations of the cryopump 50, the normal operation of the cryopump 50 is stopped, the cryopump 50 is purged under nitrogen gas, the temperature is raised to room temperature, then gas in the cryopump 50 is discharged.

As described above, the rim part of the flat surface 51c is bent in the downward direction. As described in the first cryopanel 41 shown in FIG. 7, the frost 31 is not thickly deposited at the rim part of the flat surface 51c. With this, the same effect as that described in the first modified example can be obtained in the second modified example of the first embodiment of the present invention.

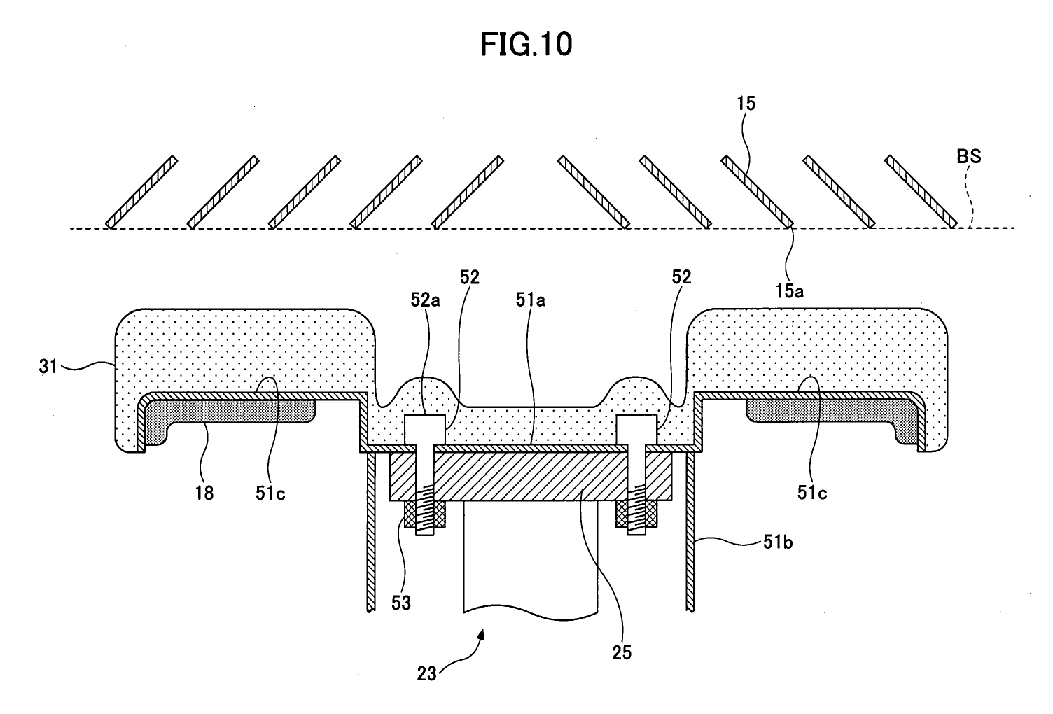

FIG. 10 is a cut-away side view in which frost is deposited on the top section 51a and the flat surface 51c of the first cryopanel 51 shown in FIG. 9.

As shown in FIG. 10, when the cryogenic cooler 20 is operated, frost 31 is formed on the surface of the first cryopanel 51 by condensing gas such as nitrogen gas, oxygen gas, and argon gas. Since the flat surface 51c is disposed at the position nearest to the baffle surface BS, the frost 31 is deposited on the flat surface 51c with the greatest thickness. On the other hand, since head surfaces 52a of the bolts 52 are located at positions lower than the position of the flat surface 51c, the frost 31 is deposited on the top section 51a with a thickness less than that on the flat surface 51c. Therefore, a problem in which the frost 112 is selectively deposited on the head surfaces 109a of bolts 109 and the deposited frost contacts the lower end of the baffle 104 shown in FIG. 2 can be avoided. Consequently, the cryopump 50 according to the second modified example of the first embodiment of the present invention can increase the discharge amount without making the size large.

As described above, in the cryopump 50, the flat surface 51c of the first cryopanel 51 disposed at the position nearest to the baffle 15 is almost parallel to the baffle surface BS. The top section 51a is secured to the second cooling stage 25 of the cryogenic cooler 20 by the bolts 52 and the nuts 53 so that the head surfaces of the bolts 52 do not protrude upward from the level of the flat surface 51c. Therefore, the frost 31 is uniformly deposited on the flat surface 51c which frost 31 is formed by condensing the gas flowing from the baffle 15. Consequently, the surface temperature of the frost 31 becomes almost uniform and the frost 31 is prevented from contacting the baffle 15 without being excessively deposited on a part of the flat surface 51c. Therefore, the cryopump 50 according to the second modified example of the first embodiment of the present invention can increase the discharge amount without making the size large.

Result of Experiment

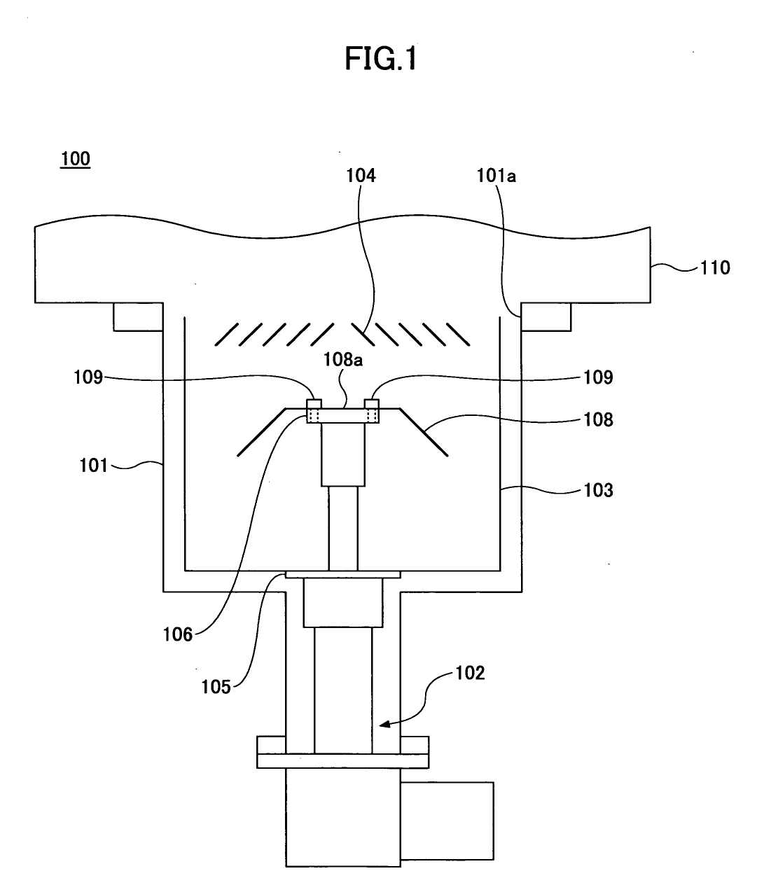

Next, an experiment to measure the discharge amount is described. In the experiment, an eight-inch size cryopump having the structure shown in FIG. 8 was used, and the discharge amount of argon gas and nitrogen gas was measured. As a comparison example, the discharge amount was measured in a cryopump in which the first cryopanel 51 shown in FIG. 8 was changed to the cryopanel 108 shown in FIG. 1. In the measurement of the discharge amount, gas to be measured is supplied to a vacuum chamber (10 liters) with the flow rate of 100 sccm, and the gas supply is stopped for 30 seconds every supplied amount of 25 SL. The discharge amount is determined as the total gas supply amount to ensure that the pressure inside the vacuum chamber is 1.33×10⁻⁵ Pa or less at the stop time.

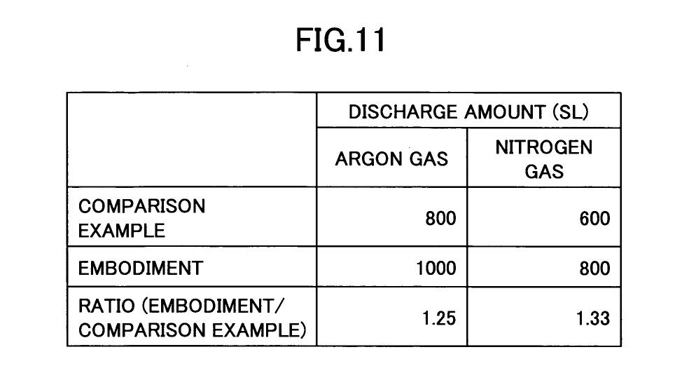

FIG. 11 is a table showing the experimental results in which the discharge amounts in the embodiment of the present invention and the comparison example are shown.

As shown in FIG. 11, in the results of the experiment, the discharge amount of the embodiment of the present invention has 1.25 times of that of the comparison example in argon gas, and has 1.33 times of that of the comparison example in nitrogen gas. Therefore, the cryopump of the embodiment of the present invention can increase the discharge amount without making the size large.

### Second Embodiment

Next, a second embodiment of the present invention is described. In the second embodiment of the present invention, a semiconductor device manufacturing apparatus using a cryopump is described. In the following, the cryopump according to the first embodiment of the present invention is used in the semiconductor device manufacturing apparatus.

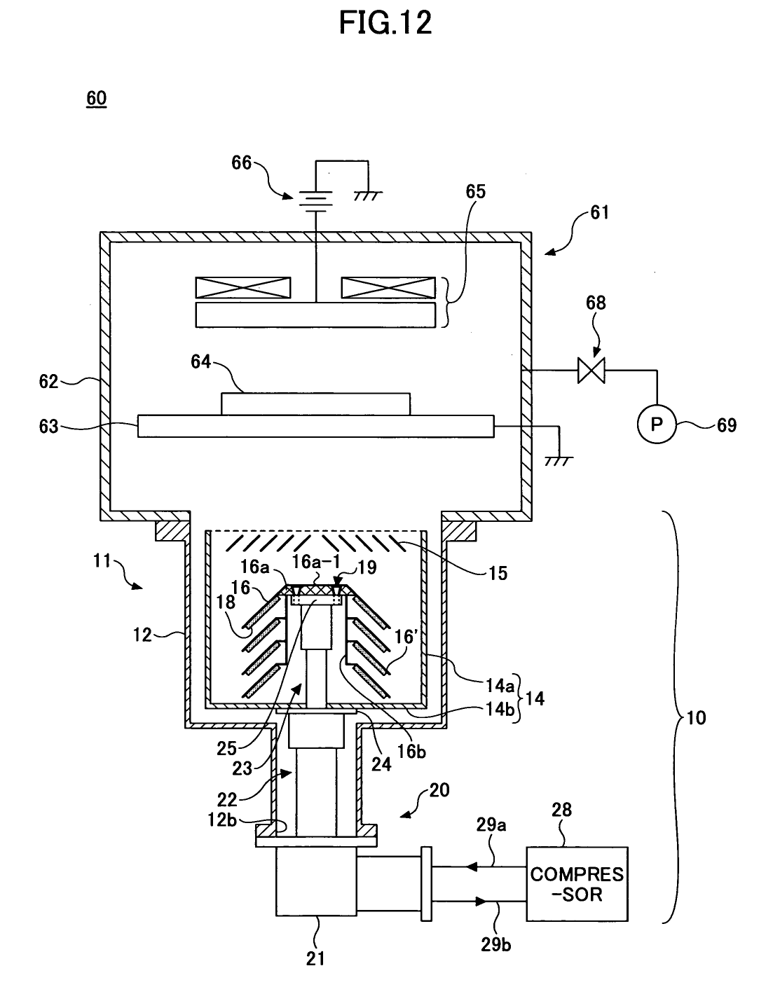

FIG. 12 is a cut-away side view of the semiconductor device manufacturing apparatus according to the second embodiment of the present invention. As described above, in FIG. 12, the cryopump 10 shown in FIG. 3 is used in a semiconductor device manufacturing apparatus 60. Therefore, the description of the cryopump 10 is omitted. As the semiconductor device manufacturing apparatus 60, a sputtering apparatus is described.

As shown in FIG. 12, the semiconductor device manufacturing apparatus 60 provides a sputtering apparatus main body 61 and the cryopump 10 for discharging gas inside a vacuum chamber 62 of the sputtering apparatus main body 61. The sputtering apparatus main body 61 includes a table 63 having a heating function on which table a wafer 64 is put, magnetron electrodes 65 having a target film forming material disposed to face the table 64, a power source 66 for supplying power to the magnetron electrodes 65, and a roughing pump 69 and a roughing valve 68 for discharging gas in the vacuum chamber 62 so that pressure inside the vacuum chamber 62 becomes a predetermined vacuum by which the cryopump 10 can be operated.

In the second embodiment, the cryopump 10 shown in FIG. 3 according to the first embodiment of the present invention is used; however, the cryopump 40 according to the first modified example of the first embodiment shown in FIG. 7 or the cryopump 50 according to the second modified example of the first embodiment shown in FIG. 8 can be used instead of the cryopump 10.

In FIG. 12, a gas supplying mechanism for supplying inert gas such as argon gas and nitrogen gas, a vacuum gage for measuring the vacuum, and a controller for controlling all the elements in the semiconductor device manufacturing apparatus 60 are not shown.

The semiconductor device manufacturing apparatus 60 discharges gas in the vacuum chamber 62 by using the roughing pump 69 and the cryopump 10 so that a predetermined vacuum can be obtained in the vacuum chamber 62. Next, for example, argon gas is supplied in the vacuum chamber 62, and electric discharge is generated by supplying power to the magnetron electrodes 65, while the cryopump 10 is operated. With this, atoms and particles of the target film forming material are deposited on the surface of the wafer 64 by sputtering the target film forming material by using ions of the argon gas.

According to the second embodiment, since the cryopump 10 can increase the discharge amount without making the size large, the working time of the semiconductor device manufacturing apparatus 60 can be decreased while the size of the semiconductor device manufacturing apparatus 60 is maintained. Consequently, the productivity of the semiconductor device manufacturing apparatus 60 can be increased. With this, cost of a semiconductor device manufactured by the semiconductor device manufacturing apparatus 60 can be reduced.

In the above, as the semiconductor device manufacturing apparatus 60, a sputtering apparatus is described. However, the cryopump in the embodiment of present invention can be applied to semiconductor device manufacturing apparatuses such as an impurity injection apparatus, a heat treatment apparatus, a chemical vapor deposition apparatus, and an etching apparatus. Further, the cryopump in the embodiment of present invention can be applied to a load lock chamber which carries wafers among plural semiconductor device manufacturing apparatuses under vacuum.

In the above embodiments, the shape of the metal plates of the second cryopanels 16′, 41′, or 51′ is not limited to any specific shape. For example, the metal plates of second cryopanels 16′, 41′, or 51′ can be fins fixed to the corresponding cylinder-shaped section 16b, 41b, or 51b.

In the above embodiments, the vertical type cryopumps 10, 40 and 50 are described. However, the embodiments of the present invention can be applied to a horizontal type cryopump. In the horizontal type cryopump, the long length direction of the cryogenic cooler 20 is almost orthogonal to the gas inputting direction from the vacuum chamber 30; however, the positional relationship between the baffle 15 and the first cryopanel 16, 41, or 51 are the same as that in the vertical type cryopump. Therefore, the embodiments of the present invention can be applied to the horizontal type cryopump.

In addition, the cryopumps according to the embodiments of the present invention can be further applied to a manufacturing apparatus which is used under vacuum such as a recording medium manufacturing apparatus for manufacturing a hard disk and an evaporation type magnetic tape, and a flat display manufacturing apparatus.

Further, the present invention is not limited to these embodiments, but variations and modifications may be made without departing from the scope of the present invention.

The present invention is based on Japanese Priority Patent Application No. 2006-158619, filed on Jun. 7, 2006, with the Japanese patent Office, the entire contents of which are hereby incorporated herein by reference.

What is claimed is:

1. A cryopump, comprising:
a vacuum container;
a two-stage type cryogenic cooler having a first cooling stage and a second cooling stage disposed in the vacuum container;
a shielding section on whose one end an inlet open to a vacuum chamber in which gas is discharged is disposed and with whose other end the first cooling stage makes contact;
a baffle which contacts the shielding section at the side of the inlet;
a first cryopanel disposed in a space surrounded by the shielding section and the baffle, which first cryopanel is in contact with the second cooling stage; and
a securing member which secures the first cryopanel to the second cooling stage; wherein
the first cryopanel includes a flat top surface almost parallel to the surface of the baffle and the top flat surface is disposed at the same level as the level of the surface of the securing member or at a level nearer to the surface of the baffle than the level of the surface of the securing member.

2. The cryopump as claimed in claim 1, wherein:
the securing member is disposed so that the surface of the securing member does not protrude from the flat top surface to the side of the surface of the baffle.

3. The cryopump as claimed in claim 1, wherein:
the first cryopanel includes a top section in contact with the second cooling stage and secured to the securing member, and
the top section has a thickness to contain the head of the securing member and the surface of the top section is flat.

4. The cryopump as claimed in claim 3, wherein:
the first cryopanel further includes a flat surface almost parallel to the surface of the baffle outside the top section.

5. The cryopanel as claimed in claim 4, wherein:
the level of the surface of the top section and the level of the flat surface are the same.

6. The cryopanel as claimed in claim 4, wherein:
the rim part of the flat surface is bent in a direction inverse to the direction where the baffle exists.

7. The cryopanel as claimed in claim 1, wherein:
the first cryopanel includes a concave section which contacts the second cooling stage and is secured to the securing member and a flat surface outside the concave section, and
the concave section has a depth capable of containing the securing member.

8. The cryopanel as claimed in claim 7, wherein:
the rim part of the flat surface is bent in a direction inverse to the direction where the baffle exists.

9. A semiconductor device manufacturing apparatus, comprising:
a vacuum chamber;
a unit which applies a film forming process, a heat treatment process, or another process to a substrate of a semiconductor device disposed in the vacuum camber; and
the cryopump as claimed in claim 1 for discharging gas in the vacuum chamber.
